(19) United States
(12) Patent Application Publication
(10) Pub. No.: US 2009/0003005 A1
(43) Pub. Date: Jan. 1, 2009

(54) Lamp Clamp For Backlight of Liquid Crystal Display

(75) Inventors: Donald Burris Clary, Rancho Palos Verdes, CA (US); Solomon L. Katrikh, Los Angeles, CA (US)

Correspondence Address: SANTOPIETRO, LOIS A.;E.I. DU PONT DE NEMOURS AND COMPANY, 4417 Lancaster Pike, Wilmington, DE, 19805, US

(73) Assignee: E.I. DU PONT DE NEMOURS AND COMPANY, Wilmington, DE (US)

(21) Appl. No.: 10/585,684

(22) PCT Filed: Mar. 23, 2005
(86) PCT No.: PCT/US05/09572

§ 371 Date: Jul. 10, 2006

Related U.S. Application Data
(60) Provisional application No. 60/555,564, filed on Mar. 23, 2004.

(51) Int. Cl. F21V 21/00

(52) U.S. Cl. 362/396

(57) ABSTRACT

The invention is directed to a clamp (501) for holding a lamp (101) within a reflector housing (201) having a body with a semi-cylindrical recess (502) having an opening for accepting a cylindrical lamp (101).

### FIELD OF THE INVENTION

The invention is directed to a flexible lamp clamp used to secure cold cathode fluorescent lamp(s) in a reflector housing used in liquid crystal display(s) (LCD).

### BACKGROUND OF THE INVENTION

Liquid-crystal displays (LCD) provided with a backlighting system that is thin and which allows for easy viewing of information on a screen are used with recent models of computers. The backlighting system in common use adopts an “edge lighting” method in which a linear light source such as a fluorescent tube is provided in proximity to one end portion of a transmissive light conducting plate or light guide. The light guide can be a rectangular solid of transparent material, for example, an acrylic; but any material that is typically used in the industry as a light guide is suitable. The purpose of the light guide in a liquid crystal display backlight is to bring in light from the side, bend it by approximately 90°, and distribute the light uniformly across the rear surface of an LCD. The most common type of devices that operate on the edge lighting method is shown in FIG. 1; wherein a cold cathode fluorescent (CCFL) lamp (101) is fixed in a reflector housing (not shown) and the light from the lamp moves through an edge of the light guide (102) a plurality of light diffusing elements are formed in dots or stripes on one face of a light guide. Rubber boots hold at least one lamp securely within the reflector. For illustrative purposes, FIG. 1 show two lamps (101) at each long lateral side of a light guide (102).

The CCFLs as found in the art are typically in the shape of long straight cylinders but may be L or U shaped and are mounted in the reflector housing. The CCFLs has cathodes located at each end wherein a connecting wire is soldered thereon. FIG. 2 illustrates a typical reflector housing (201) that is U shaped (202) in cross section.

During today's LCD manufacturing, the soft foam rubber boots are used to mount the lamps within the U shaped lamp reflector housing and to provide insulation from the high voltages of the CCFL lamps. One embodiment of a rubber boot (301) used in the industry today is illustrated in FIG. 3. A wire (304) is threaded into a channel (302), bent about 90° existing through a channel (303), and soldered onto a cathode of a lamp outside of the boot. The soldered lamp is then inserted into the larger channel (303). A completed standard industry CCFL lamp reflector assembly with soft foam rubber boot (401) is illustrated in FIG. 4. This design is labor intensive and costly to manufacture. The present invention is a lamp clamp that saves component cost and reduces installation labor. Labor costs are also reduced during repairs. The clamp as described below may be easily removed and reused on other assemblies during manufacturing or repair.

### SUMMARY OF THE INVENTION

The invention is directed to a clamp for holding a lamp within a reflector housing comprising: a body formed of a resilient, elastomeric material having at least one semi-cylindrical recess for accepting a cylindrical lamp. The invention is further directed to a clamp as described above wherein the interior of the semi-cylindrical recess is sized to be in close proximity to the circumference of the lamp. The invention is still further directed to the clamp as described above wherein the exterior of the clamp is sized to be in close proximity to the interior of a reflector. The invention is still further directed to the clamp as described above having at least two semi-cylindrical recesses. The invention is still further directed to the clamp as described above wherein a cylindrical lamp is pressed into the semi-cylindrical recess forming an assembly. The invention is still further directed to the assembly wherein the assembly is pressed into a U-shaped opening of a reflector. The invention is still further directed to a clamp assembly comprising: the clamp as described above, at least one lamp and a reflector.

### BRIEF DESCRIPTION OF THE DRAWINGS

FIG. 1 illustrates a lamp arrangement in a backlight system of a liquid crystal display as found in the art.

FIG. 2 illustrates a reflector as found in the art.

FIG. 3 illustrates a rubber boot as found in the art.

FIG. 4 illustrates a lamp reflector with rubber boot as found in the art.

FIG. 5 illustrates an embodiment of a lamp clamp.

FIG. 6 illustrates an embodiment a lamp assembly press fitted into a reflector.

FIG. 7 illustrates an embodiment of an extrusion of clamp material.

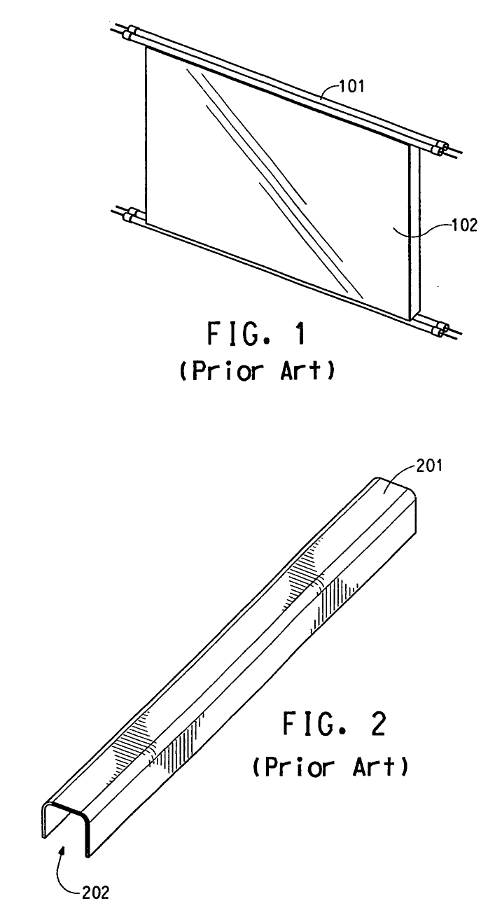

### DETAILED DESCRIPTION OF THE INVENTION

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and embodiments are illustrative only and not intended to be limiting.

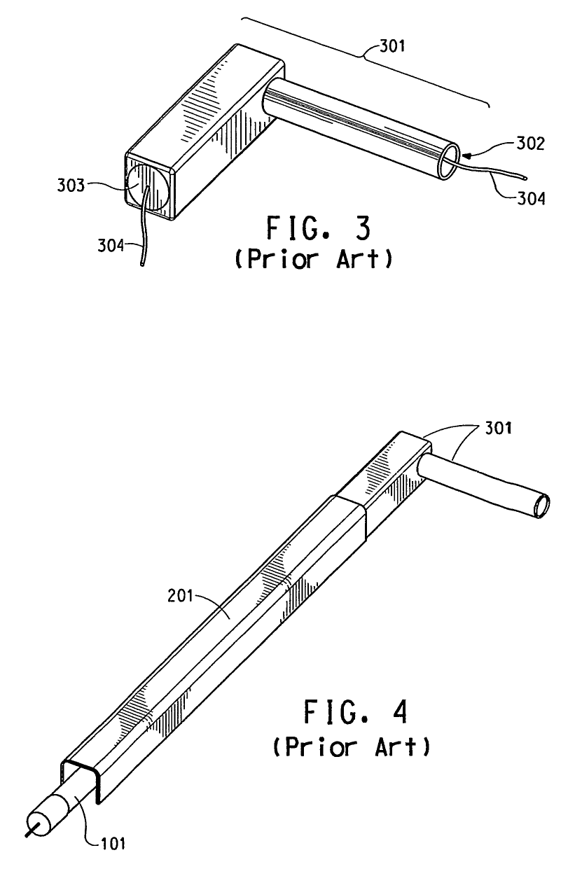

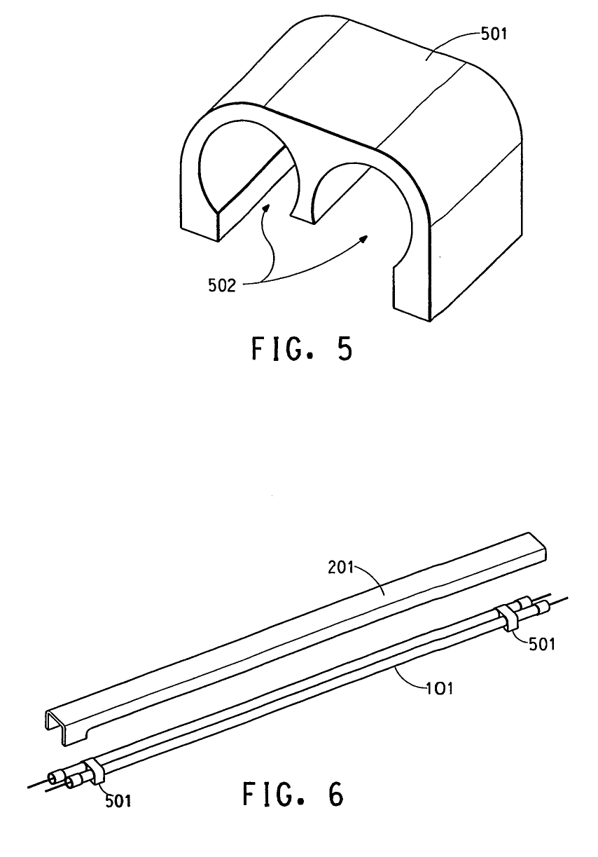

An embodiment of the present invention is illustrated in FIG. 5. The embodiment illustrates a lamp clamp (501) designed to hold 2 CCFL lamps used in a backlighting system for an LCD. Typically, when 2 or more lamps are present, they are arranged in a juxtaposed position as shown. The design may be modified to hold one lamp wherein the lamp clamp would have one semi-cylindrical recess as opposed to the two semi-cylindrical recesses (502) as shown in FIG. 5. In addition, there is no limit to the number of semi-cylindrical recesses that may be present. For example, if three lamps were used, then three recesses would be needed. For four lamps, four recesses may be needed. Moreover, there may be more than one clamp utilized. The clamp having the recess has at least one opening, to avoid threading the wire through a tube as done in the rubber boot design as shown in FIG. 3. This avoids inserting the lamps into holes in the boot. The clamp is designed to allow a simple press fit operation wherein the cylindrical lamps are pressed into the opening or openings of the semi-cylindrical recess or recesses of the clamp. This open press fit operation means that the lamp can be applied into the clamp either before or after a wire-soldering step. As explained hereinabove, the use of the standard industry rubber boot requires that soldering be completed before installing the boot on the ends of the lamps.

FIG. 6 illustrates lamp clamps (501) press-fitted over CCFL lamps (101) forming an assembly, and this assembly is then press-fitted inside a lamp reflector housing (201) forming a clamp assembly. In another embodiment, it is possible to press-fit the clamp or clamps into the reflector housing first, then press-fit the lamp or lamps into the opening of the clamp or clamps.

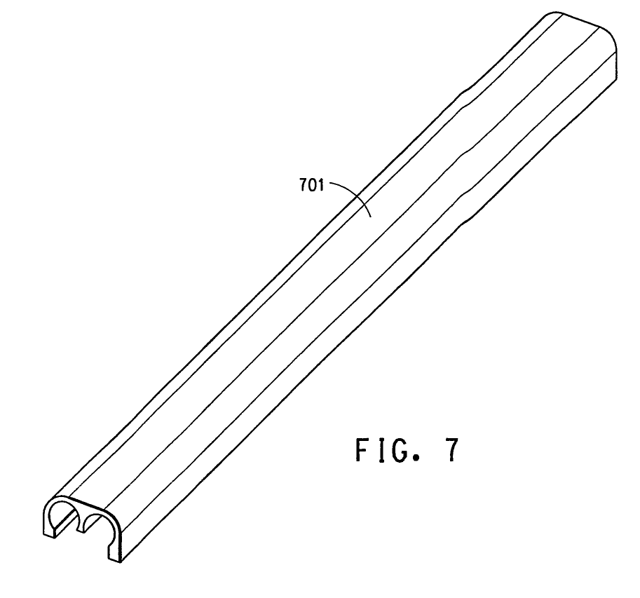

One method of creating a clamp can be by a simple extrusion process through a die. A resulting extrusion product (See FIG. 7)(701) can be cut to any desired width or length. The product material for this embodiment was chosen to be silicone, which is resilient to high temperatures created by the lamp cathodes. A translucent material such as silicone gives freedom over placement of the clamp (over the non-emitting cathode or over the emitting portion of the lamp); although any material that exhibit some of the following properties, for example, extrudable, resilient, elastomeric, flexible, heat resistant (does not degrade at high temperatures), acceptable surface friction or clinging ability, and mechanical shock resistance, may be used as a clamp material. Also, the material is preferably optically clear. Examples of such materials may be selected from silicone, polyester, polyurethane, polyethylene, neoprene, and butyl rubber; but any material that may possess some of the above listed characteristics would be a candidate. Hardness of the material may be selected to provide the proper amount of cling and friction, and to permit optimum cushioning of the CCFL lamps during shock and vibration. For example, in one embodiment a durometer hardness of 40+/−5 is acceptable.

The clamp is inexpensive to manufacture, adjustable in length (by slicing the extruded material), very fast to install, and provides CCFL lamp protection from shock and vibration damage. It is quick to remove during repairs. The only disadvantage is a lack of electrical insulation around the high voltage wire during assembly with a lamp. Using heat shrink tubing or the like around the wire can eliminate the disadvantage.

We claim:

1. A clamp for holding a lamp within a reflector housing comprising: a body having at least one semi-cylindrical recess with at least one opening for accepting a cylindrical lamp.

2. The clamp of claim 1 wherein the semi-cylindrical recess is sized to be in close proximity to the circumference of the lamp.

3. The clamp of claim 1 wherein the body has an exterior and the exterior is sized to be in close proximity to the interior of a reflector.

4. The clamp of claim 1 having at least two semi-cylindrical recesses.

5. The clamp of claim 1 wherein the body is formed of a resilient, elastomeric material.

6. The clamp of claim 5 wherein the resilient, elastomeric material is selected from silicone, polyester, polyurethane, polyethylene, neoprene, and butyl rubber.

7. The clamp of claim 1 wherein a cylindrical lamp is pressed into the opening of the semi-cylindrical recess forming an assembly.

8. The clamp of claim 7 wherein the assembly is pressed into a U-shaped opening of a reflector housing.

9. The clamp of claim 1 press-fitted into a U-shaped opening of a reflector housing.

10. A device comprising, at least one clamp of claim 1, at least one lamp and a reflector housing.
